(19) United States
(12) Patent Application Publication
(10) Pub. No.: US 2007/0178380 A1
(43) Pub. Date: Aug. 2, 2007

(54) Nonaqueous electrolyte secondary battery

(75) Inventors: Masato Iwanaga, Moriguchi-shi (JP); Hideyuki Inomata, Moriguchi-shi (JP); Keisuke Ooga, Moriguchi-shi (JP); Koji Abe, Ube-shi (JP); Kazuhiro Miyoshi, Ube-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 10/584,266

(22) PCT Filed: Dec. 24, 2004
(86) PCT No.: PCT/JP04/19328

§ 371 Date: Jun. 23, 2006

(30) Foreign Application Priority Data
Dec. 25, 2003 (JP) 2003-428675

(51) Int. Cl. H01M 4/58; H01M 10/40

(52) U.S. Cl. 429/231.4; 429/330; 429/332

(57) ABSTRACT

A nonaqueous electrolyte secondary battery comprising a negative electrode constituted of a carbonaceous material permitting reversible insertion and desorption of lithium, a positive electrode permitting reversible insertion and desorption of lithium, a separator separating these positive electrode and negative electrode from each other and a nonaqueous electrolyte composed of an organic solvent and, dissolved therein, a solute of lithium salt, wherein the nonaqueous electrolyte contains vinylene carbonate and di(2-propynyl) oxalate, these vinylene carbonate and di(2-propynyl) oxalate added in an amount of 0.1 to 3.0% by mass and 0.1 to 2.0% by mass, respectively, based on the mass of the nonaqueous electrolyte. Thus, there can be provided a nonaqueous electrolyte secondary battery wherein a stable SEI surface coating is formed to thereby exhibit a large initial capacity and excel in cycle characteristics at high temperature and wherein any cell swelling is slight.

### TECHNICAL FIELD

The present invention relates to a nonaqueous electrolyte secondary battery. More particularly it relates to a nonaqueous electrolyte secondary battery that has a high initial capacity, excels in charge-discharge cycling characteristics at high temperature and undergoes slight if any swelling.

### RELATED ART

With the rapid spread of portable electronic equipment, the specifications required of the batteries used in such items have become more stringent year by year. In particular they are required to be smaller, flatter and high-capacity as well as to have excellent cycling characteristics and stable performance. In the field of secondary batteries, attention has focused on the lithium nonaqueous electrolyte secondary battery, which has high energy density compared to the other batteries. The share that lithium nonaqueous electrolyte secondary batteries account for in the secondary battery market has shown high growth.

Lithium nonaqueous electrolyte secondary batteries have a structure such that between a negative electrode made from a negative electrode core (collector) composed of copper foil or similar in elongated sheet form that is coated with negative electrode active material compound on both sides, and a positive electrode made from a positive electrode core composed of aluminum foil or similar in elongated sheet form that is coated with positive electrode active material compound on both sides, there is deployed a separator composed of microporous polyolefin film or similar; the positive and negative electrodes, insulated from each other by the separator, are wound into a cylindrical or elliptical form, and in the case of a rectangular battery the wound electrode bodies are additionally crushed into a flattened shape; a negative electrode lead and a positive electrode lead are connected to a designated portion of, respectively, the negative electrode and the positive electrode, which are housed inside a case of designated shape.

Of the lithium nonaqueous electrolyte secondary batteries that have been developed, many have positive electrode active material composed of LiCoO₂, LiNiO₂, LiMn₂O₄, LiFeO₂ or other lithium compound oxide and negative electrode active material composed of a carbonaceous material, since such batteries are nonaqueous electrolyte secondary batteries of the 4V class with particularly high energy density. The nonaqueous solvent used for such nonaqueous electrolyte secondary batteries needs to have high permittivity and to have high ion conductivity over a broad temperature range in order to dissociate the electrolyte. Accordingly an organic solvent is used, for example a carbonate such as propylene carbonate (PC), ethylene carbonate (EC), butylene carbonate (BC), dimethyl carbonate (DMC), diethyl carbonate (DEC) or ethyl methyl carbonate (EMC), or a lactone such as γ-butyrolactone, or alternatively an ether, a ketone, or an ester, etc. In particularly wide use are solvent mixtures of EC plus a low-viscosity noncyclic carbonate such as DMC, DEC or EMC.

Carbonaceous materials, particularly those composed of graphite material, are widely used as the negative electrode active material. This is because, besides having discharge potential that rivals lithium metals and lithium compounds, they are highly safe thanks to being free of dendritic growths, excel in initial efficiency, and have good potential flatness. Moreover they have the outstanding property of high density.

However, when carbonaceous materials such as graphite or amorphous carbon are used as the negative electrode active material, there exists the problem that in the charge/discharge processes the organic solvent is reductively decomposed on the electrode surfaces and the negative electrode impedance increases due to the resulting generation of gas and buildup of side reaction products, etc., causing reduced charge-discharge efficiency and deterioration of the charge-discharge cycle, etc.

Accordingly the techniques of adding various chemical compounds to the nonaqueous electrolyte in order to curb reductive decomposition of the organic solvent, and of controlling the negative electrode surface film (the solid electrolyte interface or SEI: “SEI surface coating” below), also termed the “passivated layer”, so that the negative electrode active material does not directly react with the organic solvent, have long been important. For example, Patent Documents 1 and 2 below disclose a nonaqueous electrolyte for a nonaqueous electrolyte secondary battery whereby at least one item selected from vinylene carbonate (VC) and its derivatives (Patent Document 1), or else a vinyl ethylene carbonate compound (Patent Document 2), is added to the nonaqueous electrolyte, and by means of these additives, prior to the insertion of lithium to the negative electrode for the initial charging there is formed on the negative electrode active material layer an SEI surface coating which functions as a barrier inhibiting insertion of the solvent molecules surrounding the lithium ions.

With VC on its own however, although good charge-discharge cycling and other characteristics are yielded at room temperature, there exists the problem that the battery will swell when charge-discharge cycling is implemented repeatedly at high temperature. This is thought to be because at high temperature the SEI surface coating formed via the VC dissolves, decomposing the electrolyte and generating gas.

In Patent Document 3 below it is disclosed that when at least one alkyne derivative given by General Formula (I) below is added, a nonaqueous electrolyte secondary battery excelling in charge-discharge cycling characteristics, battery capacity and storage characteristics, etc., is obtained, which, however, although it gives good charge-discharge cycling characteristics up to 50 or so cycles at room temperature, has inferior 300-cycle extended cycling characteristics, and moreover yields no improvement effects as regards charge-discharge cycling characteristics at high temperature. This is thought to be because the SEI surface coating formed via an alkyne derivative given by General Formula (I) below is prone to change properties during charge-discharge cycling or at high temperature, leading to a decline in the battery's characteristics. 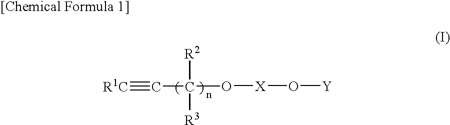
(Where each of R¹, R² and R³ represents, independently, a carbon number 1 to 12 alkyl group, carbon number 3 to 6 cycloalkyl group, carbon number 6 to 12 aryl group, carbon number 7 to 12 aralkyl group, or hydrogen atom. R² and R³ may join with each other to form a carbon number 3 to 6 cycloalkyl group. n represents the integer 1 or 2. X represents a sulfoxide group, sulfone group or oxalyl group, and Y a carbon number 1 to 12 alkyl group, alkenyl group or alkynyl group, carbon number 3 to 6 cycloalkyl group, carbon number 6 to 12 aryl group, or carbon number 7 to 12 aralkyl group.)

Patent Document 1: Japanese Laid-Open Patent Publication No. 1996-045545 (claims, and paragraphs [0009] to [0012] and [0023] to [0036])

Patent Document 2: Japanese Laid-Open Patent Publication No. 2001-006729 (claims, and paragraphs [0006] to [0014])

Patent Document 3: Japanese Laid-Open Patent Publication No. 2002-124297 (claims, and paragraphs [0012] to [0016])

### DISCLOSURE OF INVENTION

### Problems to be Solved by the Invention

The present inventors arrived at the present invention by discovering, as a result of numerous and varied investigations concerning the generation mechanism of the aforementioned SEI surface coating on the surface of the carbonaceous negative electrode, that if di(2-propynyl) oxalate (D2PO), which is given by Chemical Formula (II) below and is one of the alkyne derivatives given by General Formula (I) above, is made to bind with the VC when the latter is added into the nonaqueous electrolyte, then without lowering the initial capacity it is possible to improve the extended charge-discharge cycling characteristics at high temperature to a drastically greater degree than by adding either one on its own, as well as to curb swelling of the battery over extended cycling.

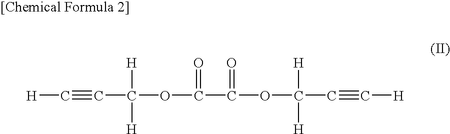

Why such a result is obtained is not certain at the present time and must await further research, but it appears likely that formation of the SEI surface coating as a mixture of D2PO and VC films has the effect of preventing property change in the D2PO film and also of curbing dissolving of the VC film during charge-discharge cycling at high temperature.

Thus, the purpose of the present invention is to provide a nonaqueous electrolyte secondary battery that forms a stable SEI surface coating, has high initial capacity, excels in charge-discharge cycling characteristics at high temperature, and moreover undergoes little if any swelling.

### Means to Resolve the Problems

The aforementioned purpose of the present invention can be achieved by means of the following structure. Namely, the invention of claim 1 is a nonaqueous electrolyte secondary battery that comprises:

a negative electrode constituted of a carbonaceous material permitting reversible insertion and desorption of lithium;

a positive electrode permitting reversible insertion and desorption of lithium; a separator separating the positive electrode and negative electrode from each other; and

a nonaqueous electrolyte composed of an organic solvent with a solute of lithium salt dissolved therein;

and has the feature that said nonaqueous electrolyte contains vinylene carbonate and di(2-propynyl) oxalate, said vinylene carbonate being added in an amount of 0.1 to 3.0% by mass, and said di(2-propynyl) oxalate in an amount of 0.1 to 2.0% by mass, relative to the mass of said nonaqueous electrolyte.

The amount in which said VC is added will preferably be 1.0 to 3.0% by mass relative to the mass of said nonaqueous electrolyte, and will most preferably be 1.0 to 2.5%. The amount in which said D2PO is added will preferably be 0.3 to 2.0% by mass relative to the mass of said nonaqueous electrolyte. The mass ratio of said VC to said D2PO with said amount ranges will preferably be 1:20 to 30:1, and will more preferably be 1:2 to 10:1.

The nonaqueous solvent (organic solvent) composing said nonaqueous electrolyte may be a carbonate, a lactone, an ether, an ester or an aromatic hydrocarbon or the like. Of those, a carbonate, lactone, ether, ketone, ester or the like will be preferable; more preferably, a carbonate will be used.

More specifically, as cyclic carbonate it will be preferable to use at least one item selected from propylene carbonate (PC), ethylene carbonate (EC) and butylene carbonate (BC), and as chain carbonate (noncyclic carbonate), at least one item selected from dimethyl carbonate (DMC), ethyl methyl carbonate (EMC) and diethyl carbonate (DEC).

Said nonaqueous solvent will preferably use a mixture of cyclic carbonate and chain carbonate. The volume ratio of the cyclic carbonate to the chain carbonate will preferably be 40:60 to 20:80, more preferably 35:65 to 25:75. Further, for the chain carbonate it will be preferable to use ethyl methyl carbonate (EMC), which is an asymmetric chain carbonate, and particularly preferable to use the asymmetric chain carbonate EMC in combination with DEC, a symmetric carbonate. The volume ratio of the percentage of EMC to that of DEC in the solvent's total volume will preferably be 70:0 to 40:30.

The electrolyte constituent of the nonaqueous electrolyte solution may be lithium perchlorate (LiCl₀₄), lithium hexafluorophosphate (LiPF₆), lithium borofluoride (LiBF₄), lithium hexafluoroarsenate (LiAsF₆), lithium trifluoromethylsulfonate (LiCF₃SO₃), lithium bistrifluoromethyl-sulfonyl-imide (LiN(CF₃SO₂)₂) or other lithium salt. Of these it will be will preferable to use LiPF₆ or LiBF₄, preferably in the dissolved amount 0.5 to 2.0 moles per liter of said nonaqueous solvent.

For the positive electrode active material there will be used, either singly, or plurally in a mixture, a lithium transition metal compound oxide, expressed as LixMO₂ (M being at least one of Co, Ni and Mn), such as LiCoO₂, LiNiO₂, LiNi_{y}Co_{1-y}O₂ (y=0.01 to 0.99) or LiMnO _{2,} LiCoₓMn_{y}Ni_{z}O₂ (x+y+z=1), or a spinel-type lithium cobalt oxide, expressed as LiMn₂O4.As necessary, said lithium transition metal compound oxide may contain different metal elements such as titanium, magnesium, zirconium and aluminum.

For the negative electrode active material there will be used a carbonaceous material that is able to store and release lithium, particularly an artificial graphite, natural graphite or other graphite.

The invention of claim 2 is the nonaqueous electrolyte secondary battery of said claim 1, with the further feature that the packing density of said negative electrode active material is 1.3 g/ml or higher. While the high packing density of the negative electrode active material is implemented for the sake of higher capacity, the effects of adding VC and D2PO to the electrolyte manifest saliently when the negative electrode packing density is 1.3 g/ml or above, and even more saliently when it is 1.5 g/ml or above. This phenomenon may be considered to be due to the facts that if VC and D2PO are not both present in the electrolyte, the rise in the negative electrode packing density will produce an increase in active spots on the negative electrode surface which will promote decomposition of the electrolyte and other irreversible reactions, whereas when VC and D2PO are both present in the electrolyte, such active spots will be effectively protected by the resultant SEI coating. If the packing density of said negative electrode active material is below 1.3 g/ml, the effects that arise from adding VC and D2PO to the electrolyte will not be of any benefit. As the packing density of said negative electrode active material is increased, the initial capacity and the long-term capacity maintenance ratio at high temperature gradually fall, while the battery swelling becomes larger. Moreover, batteries with packing density exceeding 1.9 g/ml are difficult to manufacture. For these reasons the packing density should preferably be no more than 1.9 g/ml, although this is not a critical limit.

The invention of claim 3 is the nonaqueous electrolyte secondary battery of said claim 1, with the further feature that said nonaqueous electrolyte is composed of a mixed solvent of EC and noncyclic carbonate.

The invention of claim 4 is the nonaqueous electrolyte secondary battery of said claim 3, with the further feature that the proportion of said EC is 20 to 40% by volume of the mixed solvent.

The invention of claim 5 is the nonaqueous electrolyte secondary battery of said claim 3, with the further feature that said noncyclic carbonate is composed of at least one item selected from EMC, DEC and DMC.

The invention of claim 6 is the nonaqueous electrolyte secondary battery of said claim 5, with the further feature that the proportion of said DEC is 0 to 30% by volume of the mixed solvent; if some other noncyclic carbonate is present, then DEC need not be present.

The invention of claim 7 is the nonaqueous electrolyte secondary battery of any of said claims 1 to 6, with the further feature that said nonaqueous electrolyte secondary battery is deployed inside a metallic case whose thickness is 0.15 to 0.50 mm. A case thickness of less than 0.50 mm is not desirable since it would result in low capacity maintenance ratio and in large swelling of the battery. A case thickness exceeding 0.15 mm is not desirable since it would result in lower initial capacity of the battery and in the effects that arise from adding VC and D2PO to the electrolyte not being of any benefit. The metallic case will preferably be made of an aluminum alloy, but alternatively stainless steel, iron or the like might be used.

### Effect of the Invention

With the present invention, VC and D2PO are added simultaneously to the nonaqueous electrolyte. Thanks to this the stability of the SEI coating is high and, as will be described below, an outstanding nonaqueous electrolyte secondary battery can be obtained that has high initial capacity, excels in cycling characteristics at high temperature, and moreover undergoes little if any swelling.

### BEST MODE FOR CARRYING OUT THE INVENTION

The best mode for carrying out the present invention will now be described in detail using practical examples and comparative examples. First are described the specific manufacturing methods for the nonaqueous electrolyte secondary battery that are common to the practical examples and the comparative examples.

<Fabrication of Positive Electrode Plate>

The positive electrode active material constituted of LiCoO₂ was made into a slurry or paste of active material by mixing it with acetylene black, graphite or other carbonaceous conductant (in for example the proportion of 3% by mass) and a binder or similar (in for example the proportion of 3% by mass) constituted of polyvinylidene fluoride (PVdF) dissolved into an organic solvent or similar composed of N-methylpyrrolidone. Such active material slurry or active material paste was then applied evenly to both sides of the positive electrode core (of for example 15 μm thick aluminum foil or aluminum mesh), using a die coater, doctor blade or similar in the case of slurry, and using the roller coating or similar method in the case of paste, thus forming a positive electrode plate coated with an active material layer. Subsequently the positive electrode plate coated with an active material layer was passed through a drying machine to remove the organic solvent which had been needed during preparation of the slurry or paste, and to dry the plate. Then the dried positive electrode plate was rolled by a roller pressing machine into a positive electrode plate of thickness 0.14 mm.

<Fabrication of Negative Electrode Plate>

A slurry or paste was made by mixing the negative electrode active material constituted of natural graphite, together with a binder or similar (in for example the proportion of 3% by mass) constituted of PVdF, into a solution of organic solvent or similar composed of N-methylpyrrolidone. Such slurry or paste was then applied evenly all over both sides of the negative electrode core (of for example 10 μt m thick copper foil), using a die-coater, doctor blade or similar in the case of slurry, and using the roller coating or similar method in the case of paste, thus forming a negative electrode plate coated with an active material layer. Subsequently the negative electrode plate coated with an active material layer was passed through a drying machine to remove the organic solvent which had been needed during preparation of the slurry or paste, and to dry the plate. Afterward the dried negative electrode plate was rolled by a roller pressing machine into a negative electrode plate of thickness 0.13 mm. The packing density of the negative electrode active material was adjusted to the designated value by varying the rolling pressure of the roller pressing machine.

<Fabrication of Electrode Bodies>

A positive electrode plate and a negative electrode plate fabricated in the manner described above were placed one on either side of a microporous membrane (for example of thickness 0.022 mm) that was constituted of polyolefin resin, which has low reactivity with organic solvent, and that served as a separator, and the two electrode plates were precisely aligned with each other so that their width-direction centerlines coincided. Subsequently the electrode plates were wound by a winder and their outermost windings were secured with tape, the resulting items serving as spiral electrode bodies for the practical and comparative examples. Then each of the electrode bodies fabricated in the foregoing manner was inserted into a rectangular case made of aluminum alloy of a designated thickness, and the positive electrode current collecting tabs and negative electrode current collecting tabs projecting from the electrode bodies were welded together with the case.

<Preparation of Electrolyte>

The electrolyte was prepared by dissolving LiPF₆ so as to constitute a proportion of 1 mole par liter in a solvent of EC mixed with noncyclic carbonate in designated relative proportions, then adding VC and D2PO in particular amounts as required.

<Fabrication of Battery>

For all of the practical examples and comparative examples, a nonaqueous electrolyte secondary battery of design capacity 750 mAh was fabricated by pouring the requisite amount of the applicable electrolyte through the mouth of the case, then sealing the case.

<Charge-Discharge Conditions>

For each of the practical examples and comparative examples fabricated in the foregoing manner, various charge-discharge tests were conducted under the charge-discharge conditions that are set forth below. All the charge-discharge tests were conducted inside a constant-temperature tank maintained at 40° C.

<Measurement of Initial Capacity>

First of all, each battery was charged at constant current of 1 It =750 mA (1C) until the battery voltage reached 4.2 V, then charged at constant voltage of 4.2 V until the current became 20 mA, after which discharge was implemented at constant current of 1 It until the battery voltage reached 3.0 V. The discharge capacity at that point was determined and taken as the initial capacity.

<Measurement of Cycling Characteristics>

Cycling characteristics were measured as follows. One cycle was taken to be the process of charging the battery at constant current of 1 It until the battery voltage reached 4.2 V, then charging at constant voltage of 4.2 V until the current became 20 mA, followed by implementation of discharge at constant current of 1 It until the battery voltage reached 3.0 V. Each of the batteries whose initial capacity had been measured was made to repeat the cycle 300 times, and the discharge capacity after 300 cycles was determined. Then the capacity maintenance ratio (%) of each battery was determined according to the following calculation equation:
Capacity maintenance ratio (%)=(discharge capacity after 300 cycles/initial capacity)×100
<Measurement of Battery Swelling>

The swelling of each of the batteries whose said cycling characteristics had been measured was measured with a micrometer.

### PRACTICAL EXAMPLES 1 TO 7 AND COMPARATIVE EXAMPLES 1 to 6

The nonaqueous electrolyte secondary batteries of practical examples 1 to 7 and comparative examples 1 to 6 were fabricated using as the electrolyte a nonaqueous electrolyte solvent mixture of EC and EMC in the volume ratio 30:70, into which LiPF₆ was dissolved so as to constitute a proportion of 1 mole par liter, and to which VC and D2PO were added in the respective proportions given in Table 1. Measurement of the initial capacity, capacity maintenance ratio and swelling of each battery was then carried out. For all the batteries, the packing density of the negative electrode was 1.5 g/ml and the thickness of the case was 0.3 mm. The results are compiled in Table 1.

TABLE 1

| | | | Initial | Capacity | Battery |
|---|---|---|---|---|---|
| | VC (% by | D2PO (% by | capacity | maintenance | swelling |
| | mass) | mass) | (mAh) | ratio (%) | (mm) |
| Comparative | 0.0 | 0.0 | 780 | 63 | 6.10 |
| example 1 | | | | | |
| Comparative | 2.0 | 0.0 | 775 | 88 | 6.00 |
| example 2 | | | | | |
| Comparative | 0.0 | 1.0 | 780 | 75 | 6.05 |
| example 3 | | | | | |
| Practical | 0.1 | 1.0 | 779 | 80 | 5.80 |
| example 1 | | | | | |
| Practical | 1.0 | 1.0 | 777 | 86 | 5.78 |
| example 2 | | | | | |
| Practical | 2.0 | 1.0 | 775 | 88 | 5.75 |
| example 3 | | | | | |
| Practical | 3.0 | 1.0 | 773 | 90 | 5.69 |
| example 4 | | | | | |
| Comparative | 4.0 | 1.0 | 765 | 90 | 5.68 |
| example 4 | | | | | |
| Comparative | 1.0 | 0.0 | 777 | 85 | 6.03 |
| example 5 | | | | | |
| Practical | 1.0 | 0.1 | 776 | 85 | 5.75 |
| example 5 | | | | | |
| Practical | 1.0 | 1.0 | 777 | 86 | 5.78 |
| example 6 | | | | | |
| Practical | 1.0 | 2.0 | 778 | 85 | 5.80 |
| example 7 | | | | | |
| Comparative | 1.0 | 3.0 | 776 | 84 | 5.90 |
| example 6 | | | | | |

Solvent system: EC and EMC in ratio 30:70, plus 1 mole par liter LiPF₆
Negative electrode packing density: 1.5 g/ml
Thickness of case: 0.3 mm

According to the results given in Table 1, the following matters are evident. Namely, in comparative example 1 where neither VC nor D2PO is added, the initial capacity is high at 780 mAh, but the capacity maintenance ratio after 300 cycles is extremely low at 63% and the battery swelling is a large 6.10 mm. Further, in comparative examples 2 and 5 where VC is added but D2PO is not, the initial capacity and the capacity maintenance ratio after 300 cycles is high but the battery swelling is large at 6.00 to 6.03 mm, whereas in comparative example 3 where VC is not added but D2PO is, the initial capacity is high but the capacity maintenance ratio is low at 75% and the battery swelling is a large 6.05 mm.

By contrast, in practical examples 1 to 7 where both VC and D2PO are added, extremely good results are obtained, the initial capacity being somewhat lower than in comparative example 1 but nevertheless 773 mAh or higher, while the capacity maintenance ratio after 300 cycles is in all these examples 80% or higher and the battery swelling after 300 cycles is small at 5.80 mm or less in all these examples. However, in comparative example 4 where VC is added in a large amount of 4.0% by mass, effects comparable to practical examples 1 to 7 are yielded as regards capacity maintenance ratio and battery swelling, although the initial capacity is low at 765 mAh. Further, in comparative example 6 where D2PO is added in a large amount of 3.0% by mass, effects comparable to practical examples 1 to 7 are yielded as regards initial capacity and capacity maintenance ratio, but battery swelling is large at 5.90 mm. Thus, according to the results given in Table 1, it is evident that adding VC and D2PO simultaneously yields excellent effects and that the amount in which VC is added should preferably be 0.1 to 3.0% by mass relative to the mass of the electrolyte, while the amount in which D2PO is added should preferably be 0.1 to 2.0% by mass relative to the mass of the electrolyte.

### PRACTICAL EXAMPLES 8 TO 14 AND COMPARATIVE EXAMPLE 7

In practical examples 8 to 14 and comparative example 7, a mixture of the cyclic carbonate EC plus, as noncyclic carbonate, EMC either alone or with DEC, in the respective proportions given in Table 2, was used for the electrolyte's solvent system, to which were added LiPF₆ as supporting salt in an amount constituting 1 mole par liter, and both the VC (1.0% by mass) and D2PO (1.0% by mass) constituents. The initial capacity, capacity maintenance ratio and battery swelling of the present examples were measured in the same way as for practical examples 1 to 7 and comparative examples 1 to 6. In all the present examples the packing density of the negative electrode was 1.5 g/ml and the thickness of the case was 0.3 mm. The results are compiled in Table 2.

TABLE 2

| | | | | | Capacity | |
|---|---|---|---|---|---|---|
| | EC | EMC | DEC | Initial | mainte- | Battery |
| | (% by | (% by | (% by | capacity | nance | swelling |
| | volume) | volume) | volume) | (mAh) | ratio (%) | (mm) |
| Practical | 30 | 70 | 0 | 777 | 86 | 5.78 |
| example 8 | | | | | | |
| Practical | 30 | 65 | 5 | 776 | 87 | 5.72 |
| example 9 | | | | | | |
| Practical | 30 | 60 | 10 | 774 | 89 | 5.69 |
| example 10 | | | | | | |
| Practical | 30 | 50 | 20 | 771 | 87 | 5.65 |
| example 11 | | | | | | |
| Practical | 30 | 40 | 30 | 770 | 86 | 5.66 |
| example 12 | | | | | | |
| Comparative | 30 | 30 | 40 | 764 | 84 | 5.65 |
| example 7 | | | | | | |
| Practical | 20 | 70 | 10 | 779 | 83 | 5.78 |
| example 13 | | | | | | |
| Practical | 40 | 50 | 10 | 774 | 89 | 5.76 |
| example 14 | | | | | | |

Solvent system: VC (1.0% by mass) + D2PO (1.0% by mass), 1 mole par liter LiPF₆
Negative electrode packing density: 1.5 g/ml
Thickness of case: 0.3 mm

According to the results given in Table 2, the following matters are evident. Namely, in practical examples 10, 13 and 14 where the amount of DEC is 10% by volume, despite the fact that the amount of EC cyclic carbonate varies from 20 to 40% by volume almost no difference arises in the battery characteristics, except that there is a tendency for somewhat high initial capacity when the EC amount is low and for somewhat decreased initial capacity, together with small swelling of the battery, when the EC amount increases. In practical examples 8 to 12 and comparative example 7, where the EC amount is uniformly 30% by volume, a tendency is observed for the initial capacity to decrease gradually, and for the battery swelling to become smaller, as the DEC amount increases, but when the DEC amount is at the high level of 40% by volume the initial capacity falls drastically. Thus the EC should preferably be 20 to 40% by volume, and where DEC is added in addition to EC, the DEC should preferably be no more than 30% by volume. DEC need not be added if another noncyclic carbonate is added.

### PRACTICAL EXAMPLES 15 TO 18 AND COMPARATIVE EXAMPLES 8 to 11

For practical examples 15 to 18 and comparative examples 8 to 11, a nonaqueous electrolyte secondary battery was constructed that could accommodate a negative electrode constituted of carbonaceous material with packing density varying from 1.3 to 1.9 g/ml, and electrolyte having a uniform solvent composition of EC: EMC: DEC=30:60:10, with LiPF₆ added as supporting salt in an amount constituting 1 mole par liter, and with both the VC (1.0% by mass) and D2PO (1.0% by mass) constituents added in some cases (practical examples 15 to 18) but neither added in other cases (comparative examples 8 to 11). The initial capacity, capacity maintenance ratio and battery swelling of the present examples were measured in the same way as for practical examples 1 to 7 and comparative examples 1 to 6. In all the present examples the thickness of the case was 0.3 mm. The results are compiled in

TABLE 3

| | | | Initial | Capacity | Battery |
|---|---|---|---|---|---|
| | Packing | | capacity | maintenance | swelling |
| | density | VC + D2PO | (mAh) | ratio (%) | (mm) |
| Comparative | 1.3 | Absent | 773 | 83 | 5.68 |
| example 8 | | | | | |
| Comparative | 1.5 | Absent | 771 | 66 | 6.00 |
| example 9 | | | | | |
| Comparative | 1.7 | Absent | 765 | 45 | 6.25 |
| example 10 | | | | | |
| Comparative | 1.9 | Absent | 751 | 16 | 6.68 |
| example 11 | | | | | |
| Practical | 1.3 | Present | 776 | 91 | 5.66 |
| example 15 | | | | | |
| Practical | 1.5 | Present | 774 | 89 | 5.69 |
| example 16 | | | | | |
| Practical | 1.7 | Present | 771 | 88 | 5.70 |
| example 17 | | | | | |
| Practical | 1.9 | Present | 766 | 84 | 5.73 |
| example 18 | | | | | |

Electrolyte: EC, EMC and DEC in ratio 30:60:10, plus 1 mole par liter LiPF₆, VC (1.0% by mass) and D2PO (1.0% by mass)
Thickness of case: 0.3 mm

In comparative examples 8 to 11 where neither VC nor D2PO is added, as the packing density of the negative electrode constituted of carbonaceous material rises from 1.3 to 1.9 g/ml, the initial capacity decreases slightly but the capacity maintenance ratio decreases drastically and also the battery swelling increases markedly. However, when both VC and D2PO are added, then even though the packing density of the negative electrode constituted of carbonaceous material rises from 1.3 to 1.9 g/ml, the initial capacity maintains substantially the same level as in comparative examples 8 to 11; moreover the capacity maintenance ratio decreases only slightly and the battery swelling increases only slightly. While such high packing density of the negative electrode active material is implemented for the sake of higher capacity of the battery, the effects of adding VC and D2PO to the electrolyte manifest saliently when the negative electrode packing density is 1.3 g/ml or above, and even more saliently when it is 1.5 g/ml or above. A packing density of less than 1.3 g/ml for said negative electrode active material will result in the effects that arise from adding VC and D2PO to the electrolyte not being of any benefit and is therefore undesirable. As the packing density of said negative electrode active material is increased, the initial capacity and the long-term capacity maintenance ratio at high temperature gradually fall while the battery swelling becomes larger. In addition, batteries with packing density exceeding 1.9 g/ml are difficult to manufacture. For these reasons the packing density should preferably be no more than 1.9 g/ml, although this is not a critical limit.

### PRACTICAL EXAMPLES 19 TO 24 AND COMPARATIVE EXAMPLES 12 to 17

For practical examples 19 to 24 and comparative examples 12 to 17, a solvent of EC, EMC and DEC in the volume ratio 30:60:10 into which LiPF₆ was dissolved to an amount of 1 mole par liter was used as the nonaqueous electrolyte solvent, the thickness of the case varied from 0.50 to 0.15 mm, and a nonaqueous electrolyte secondary battery was constructed that could accommodate electrolyte with both VC (1.0% by mass) and D2PO (1.0% by mass) constituents added (practical examples 19 to 24) or with neither added (comparative examples 12 to 17). The initial capacity, capacity maintenance ratio and battery swelling of the present examples were measured in the same way as for practical examples 1 to 7 and comparative examples 1 to 6. In all the present examples the packing density of the negative electrode was 1.5 g/ml. The results are compiled in Table 4.

TABLE 4

| | Case | | Initial | Capacity | Battery |
|---|---|---|---|---|---|
| | thickness | | capacity | maintenance | swelling |
| | (mm) | VC + D2PO | (mAh) | ratio (%) | (mm) |
| Comparative | 0.5 | Absent | 775 | 83 | 5.78 |
| example 12 | | | | | |
| Comparative | 0.4 | Absent | 775 | 80 | 5.81 |
| example 13 | | | | | |
| Comparative | 0.3 | Absent | 773 | 68 | 6.01 |
| example 14 | | | | | |
| Comparative | 0.25 | Absent | 771 | 58 | 6.22 |
| example 15 | | | | | |
| Comparative | 0.2 | Absent | 769 | 47 | 6.43 |
| example 16 | | | | | |
| Comparative | 0.15 | Absent | 768 | 32 | 6.68 |
| example 17 | | | | | |
| Practical | 0.5 | Present | 774 | 88 | 5.62 |
| example 19 | | | | | |
| Practical | 0.4 | Present | 775 | 90 | 5.65 |
| example 20 | | | | | |
| Practical | 0.3 | Present | 774 | 89 | 5.69 |
| example 21 | | | | | |
| Practical | 0.25 | Present | 773 | 88 | 5.71 |
| example 22 | | | | | |
| Practical | 0.2 | Present | 775 | 86 | 5.73 |
| example 23 | | | | | |
| Practical | 0.15 | Present | 773 | 85 | 5.76 |
| example 24 | | | | | |

Electrolyte: EC, EMC and DEC in ratio 30:60:10, plus 1 mole par liter LiPF₆, VC (1.0% by mass) and D2PO (1.0% by mass)
Negative electrode packing density: 1.5 g/ml

In comparative examples 12 to 17 where neither VC nor D2PO is added, as the thickness of the case falls from 0.50 to the thin 0.15 mm, the initial capacity decreases slightly but the capacity maintenance ratio decreases drastically and also the battery swelling increases markedly. However, when both VC and D2PO are added, then even though the thickness of the case falls from 0.50 to the thin 0.15 mm, the initial capacity maintains substantially the same level as in comparative examples 12 to 17, while moreover the capacity maintenance ratio is drastically higher than in comparative examples 12 to 17 and the battery swelling is drastically smaller than in comparative examples 12 to 17. Such effects of adding VC and D2PO to the electrolyte are influenced by the thickness of the case, manifesting saliently when the thickness is 0.50 to 0.15 mm. A thickness exceeding 0.50 mm for said case is not desirable as it would result in the effects that arise from adding VC and D2PO to the electrolyte not being of any benefit. Neither is a thickness of less than 0.15 mm be desirable, as it would result in a marked fall in the capacity maintenance ratio as well as a marked increase in battery swelling.

1. A nonaqueous electrolyte secondary battery comprising:
a negative electrode constituted of a carbonaceous material permitting reversible insertion and desorption of lithium;
a positive electrode permitting reversible insertion and desorption of lithium; a separator separating the positive electrode and negative electrode from each other; and
a nonaqueous electrolyte composed of an organic solvent with a solute of lithium salt dissolved therein;
said nonaqueous electrolyte containing vinylene carbonate and di(2-propynyl) oxalate, and said vinylene carbonate being added in an amount of 0.1 to 3.0% by mass, and said di(2-propynyl) oxalate in an amount of 0.1 to 2.0% by mass, relative to the mass of said nonaqueous electrolyte.

2. The nonaqueous electrolyte secondary battery according to claim 1, wherein the packing density of said negative electrode active material is 1.3 g/ml or higher.

3. The nonaqueous electrolyte secondary battery according to claim 1, wherein said nonaqueous electrolyte is composed of a mixed solvent of ethylene carbonate and noncyclic carbonate.

4. The nonaqueous electrolyte secondary battery according to claim 3, wherein the proportion of said ethylene carbonate is 20 to 40% by volume of the mixed solvent.

5. The nonaqueous electrolyte secondary battery according to claim 3, wherein said noncyclic carbonate is composed of at least one item selected from ethyl methyl carbonate, diethyl carbonate and dimethyl carbonate.

6. The nonaqueous electrolyte secondary battery according to claim 5, wherein the proportion of said diethyl carbonate is 0 to 30% by volume of the mixed solvent.

7. The nonaqueous electrolyte secondary battery according to claim 1, wherein said nonaqueous electrolyte secondary battery is deployed inside a metallic case whose thickness is 0.15 to 0.50 mm.
